(19) United States
(12) Patent Application Publication
(10) Pub. No.: US 2014/0214930 A1
(43) Pub. Date: Jul. 31, 2014

(54) CHANGING SETTINGS

(71) Applicant: Richard Hayman-Joyce, Middlesex (GB)

(72) Inventor: Richard Hayman-Joyce, Middlesex (GB)

(21) Appl. No.: 13/750,884

(22) Filed: Jan. 25, 2013

(51) Int. Cl. H04L 12/58

(52) U.S. Cl. CPC H04L 51/32
USPC 709/204

(57) ABSTRACT

A computing system is able to modify one or more settings controlling the operation of an interactive application system. The interactive application system is configured with a plurality of accounts to enable, at least, attribution and authorization by the interactive application system of interactions with the interactive application system. One or more settings control the operation of the interactive application system with regards to the interactions and the accounts. The computing system is configured to receive a plurality of inputs in relation to a first setting of the one or more settings, the inputs being associated with different ones of the plurality of the accounts. The computing system then correlates the plurality of inputs and modifies the first setting in dependence on the correlated inputs.

### BACKGROUND OF THE INVENTION

1. Field of the Invention

The following relates to a computing system for modifying one or more settings controlling the operation of an interactive application system.

2. Description of the Related Technology

Interactive application, for example those used to provide social media, collaboration tools or document management systems, store a number of accounts. Each account may be associated with a single user, or a collection of users. Each account may be a member of one or more groups. Within the context of a group, one or more accounts—often the account used to create the group—may be provided with particular privileges such as administrator or moderator privileges. These may enable the account to make changes to setting associated with the group. Other accounts do not possess these privileges.

For example, in a typical discussion forum, any account may create a given discussion group. The creator account is automatically made an administrator and moderator of the new group. The administrator/moderator may set preferences for the group, such as setting whether the group is open (any account can join the group) or closed (to join, an account must be approved by an existing member, or the administrator himself). The administrator/moderator may also control who is in the group—i.e. by removing accounts from the group. In the context of a discussion forum, an administrator/moderator may moderate posts by deleting or editing posts. This may be done for a post containing abuse or profanity. An administrator/moderator may create other administrators or moderators, i.e. give higher level privileges to other accounts which are members of the group.

It can be the case that an administrator and/or moderator may not perform an adequate job. For example, the user or users associated with the administrator/moderator account may become unreasonable in administrating the group, removing members or forum posts for arbitrary or personal reasons. Equally, the user associated with the administrator/moderator account may be slow in making changes, i.e. accepting request to join a closed group. Finally, an administrator/moderator may arbitrary change the settings of a group in a manner which is undesirable.

Currently, the possible methods for dealing with such a situation are limited. One method is to have a “super-administrator” account (i.e. an account with privileges above and beyond a mere administrator or moderator) make changes to the group, such as removing privileges from an administrator. A further method is for a rival group to be created, with a different administrator/moderator. However, these methods are often impractical to implement. Therefore, there is a desire to improve how settings associated with accounts and/or groups on a computing system are changed.

### SUMMARY

In accordance with at least one embodiment, methods, devices, systems and software are provided for supporting or implementing functionality to modifying one or more settings controlling the operation of an interactive application system.

This is achieved by a combination of features recited in each independent claim. Accordingly, dependent claims prescribe further detailed implementations of various embodiments.

According to an exemplary embodiment, there is provided a computing system for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the computing system being configured to: receive a plurality of inputs in relation to a first setting of the one or more settings, the inputs being associated with different ones of the plurality of the accounts; correlate the plurality of inputs; and modify the first setting in dependence on the correlated inputs.

According to a further exemplary embodiment there is provided a computer program product comprising a non-transitory computer-readable storage medium having computer readable instructions stored thereon, the computer readable instructions being executable by a computerized system to cause the computerized system to perform a method for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the method comprising: receiving a plurality of inputs in relation to a first setting of the one or more settings, the inputs being associated with different ones of the plurality of the accounts; correlating the plurality of inputs; and modifying the first setting in dependence on the correlated inputs.

Further features and advantages will become apparent from the following description of preferred embodiments, given by way of example only, which is made with reference to the accompanying drawings.

### BRIEF DESCRIPTION OF THE DRAWINGS

Methods, devices, systems and software will now be described as embodiments, by way of example only, with reference to the accompanying figures in which:

FIG. 1 shows a schematic diagram of a system 1;

FIG. 2 shows a schematic diagram of a communications device shown in FIG. 1;

FIG. 3 shows a schematic diagram of the server system 8 shown in FIG. 1;

FIG. 4 shows a method according to an embodiment;

FIG. 5 shows another method according to an embodiment; and

FIG. 6 shows further method according to an embodiment.

Several parts and components of the embodiments appear in more than one Figure; for the sake of clarity the same reference numeral will be used to refer to the same part and component in all of the Figures.

### DETAILED DESCRIPTION OF CERTAIN INVENTIVE EMBODIMENTS

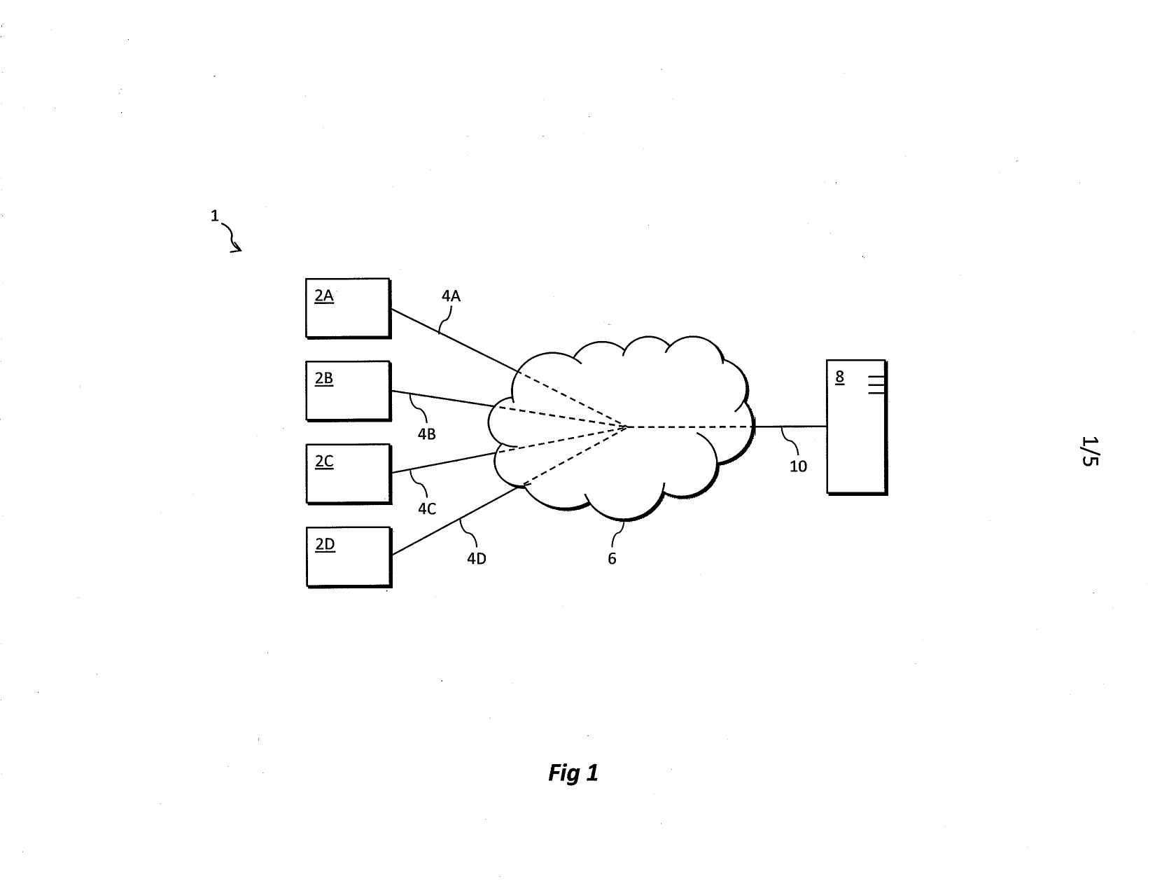

A system 1 in which embodiments may be practiced is shown in FIG. 1. The system 1 contains multiple communications devices, shown as devices 2A, 2B, 2C and 2D. These communications devices 2A, 2B, 2C and 2D have connections 4A, 4B, 4C and 4D respectively to a network 6. A server system 8 is also connected to the network 6 via a connection 10.

The communications devices 2A, 2B, 2C and 2D may be user equipment such as a computer, tablet, internet capable mobile telephone (i.e. smartphone) or the like. The network 6 may represent the internet, a local area network or a combination of the two. The server system 8 may be a single entity, or distributed, i.e. be located in the cloud. The connections 4A, 4B, 4C and 4D and 10 may be wireless, wired, or a combination of the two.

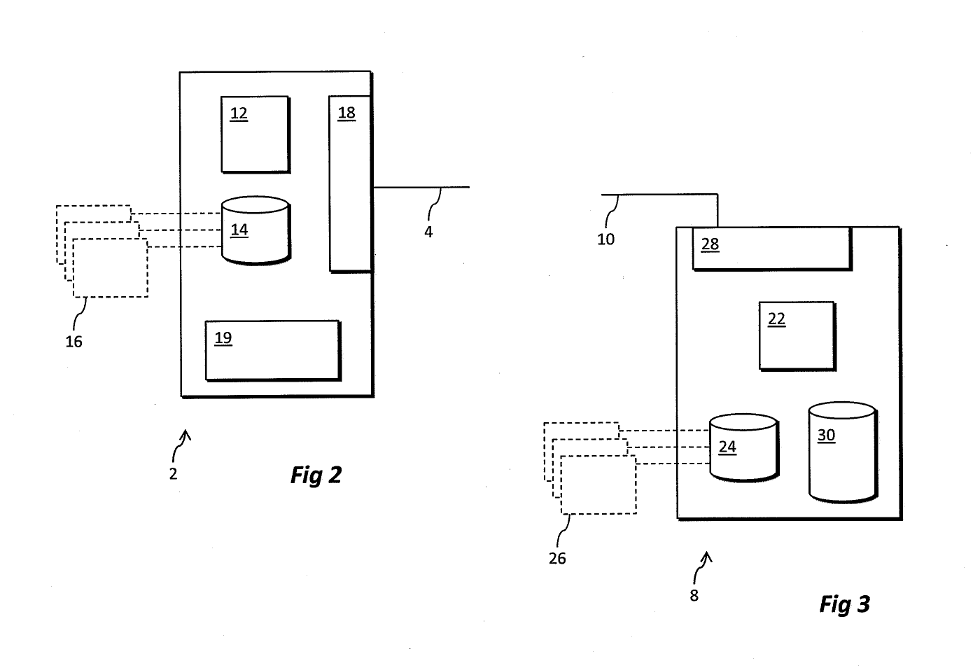

Henceforth, where reference needs to be made to any of the devices 2A, 2B, 2C or 2D, and where differentiation is not required, these devices will be referred to as device 2 or as devices 2. FIGS. 2 and 3 show more detail of the components of the device 2 and server system 8 respectively.

In FIG. 2, the device 2 is provided with a processing system 12 and a memory 14. An interface 18 connects the device 2 to the connection 4 (representing any of connections 4A, 4B, 4C or 4D above). The processing system 12 may contain a CPU, cache memory, bus and the like as are known in the art. The memory 14 may be volatile or non-volatile, such as a hard drive, flash memory, RAM or similar, and any combination of the same. The interface 18 may operate according to a number of known standards, and may be configured appropriately. For example the interface 18 may be a cellular, i.e. 3G or LTE standard wireless interface, a 802.11 (WiFi) interface, Ethernet, or any other suitable type. In addition, the device 2 may comprise, or be connected to, any number of human interface elements, represented by unit 19. This unit 19 may include one or more displays and/or audio systems, as well as user input devices such as a touchscreen, buttons, keyboard, microphone and the like.

The memory 14 may store computer instructions 16 which may be executed by the processing system 12 as is known in the art. In accordance with the computer instructions 16, the processing system 12 may send messages via the interface 18 to the server system 8, whereby to provide inputs as will be described below. Equally the processing system 12 may receive messages via the interface 18, and process the data contained within. The computing instructions 16 stored in the memory 14 may be stored in a semi-permanent fashion, i.e. be applications or apps stored in their entirety on the device 2; alternatively the computing instructions 16 may be received on an on-demand basis from the server system 8, for example being markup-language data and scripting instructions received by a web browser.

FIG. 3 shows server system 8. The server system 8 comprises a processing system 22 and a memory 24. The memory contains computer readable instructions 26 which are executed by the processing system 22, as will be described in more detail later. The server system 8 further comprises an interface 28, which connects the server system 8 to connection 10 and thereby to the network 6 and devices 2. The server system 8 may further be connected to a store 30, such as a database. This store may be configured to store settings, such as application, group and/or account settings as will be described in more detail below.

In accordance with the computer instructions 26, the processing system 22 may receive messages via the interface 28 from the devices 2, whereby to receive inputs, and process the same as will be described below. In so doing, the processing system 22 may also retrieve data from the store 30 and send messages via the interface 18 to the devices 2.

It will be appreciated that in the description below, where a device 2, or server system 8, is described performing certain steps, that it is the respective processing systems 12 and 22 of these elements which are performing the steps under the control of computer instructions 16 and 26 respectively an in cooperation, as required, with the interfaces 18 and 28. In addition, the server system 8 will henceforth be referred to in the singular. It will be appreciated that this is for conciseness, and does not imply that the server system 8 is a single physical entity—i.e. the functionality of the server system 8 may be distributed.

A detailed description of the operation of the devices 2 and server system 8 according to embodiments will be provided below. Before this, and to put this operation of the system 1 into context, a general description of the use of the system will be provided, with reference to exemplary use scenarios.

In operation, the server system 8 may comprise an interactive application system. This interactive application system may be provided through the server system 8 executing interactive application embodied in computer instructions 26 stored in the memory 24. Examples of such interactive applications include, but are not limited to:
online social networks, such as Facebook™
discussion forums;
document management systems; and
online collaboration tools, including for example a Wiki.

Users may interact with the interactive application. To interact with the interactive application, the users may operate devices 2. The devices 2 may execute the computing instruction 16, and in doing so may run applications or a browser, through which the users interact with the interactive application. The devices 2 may in turn communicate with the interactive application, by sending messages to and receiving messages from the server system 8. The operation of a system 1 in enabling users to interact with an interactive application is known in the art and will not be described in detail.

To control how the users interact with the interactive application, the interactive application system is configured with a plurality of accounts, details of which may be stored in, for example, database 30. The accounts provide functionality, such as authentication, attribution and authorization (privileges), as will be described in more detail below. While an account may be linked with a single device, and is often associated with a single human user, it will be understood that in general, any device 2, and any user or group of users may operate through a given account, providing that the user and device are able to provide the authentication details associated with that account. As such in the following description, actions associated with an account will be described as being performed by the relevant account, irrespective of whether the actions are taken by a single user, or a group of users, and equally whether the actions are performed using a single device, or a collection of devices 2. Furthermore, a first action may be performed on one device, and a second action on a second device, however if they are performed using the same account, they will be described as being performed by a single account.

In addition to authentication—which may be performed by any method known in the art—attribution and authorization are two important aspects in the use of accounts. Attribution means that any actions taken by a user (or users) operating through an account are attributed to that account. In the context of a discussion forum, for example, this means that a give account is identified as contributing a given forum post. This also means that the inputs, described below, may be attributed to accounts.

Authorization defines what actions that account is able to take. For example different accounts may be allowed or prevented from viewing certain forums. Typically this authorization is effected by associating each account with privileges, which in turn control how that account is able to interact with the interactive application.

One particular set of privileges which may be provided to a given account are often called administrator or moderator privileges. While the particular details of such privileges will depend on the interactive application to which they are applied, in general an account with administrator or moderator privileges have a relatively high level of privileges and are therefore able to perform more actions in comparison to a normal account, which has a relatively low level of privileges. For example, a moderator account on a discussion forum is able to delete or edit any given forum post, whereas a normal account is only able to delete or edit posts attributed to that account.

The accounts may be arranged in groups or nodes. Depending on the nature of the interactive application, the context of the groups may be different. Nevertheless, the groups in general have at least some of the following properties:

Accounts may join and leave groups, this may require some form of approval from accounts already within the group, such as an invitation from a group member, or approval from an account with relatively higher (e.g. administrator or moderator) level privileges.

The group may be associated with particular group settings, for example there may be a setting defining whether new members of the group need approval, or how many accounts within a group may have administrator or moderator level privileges.

Certain actions may be taken by an account with respect of one group, which do not affect other groups, for example a forum post in a given group may only be viewed by the members of the group.

Some data may only be available to members of the group, for example an emailing list may only be available to members of the group, and therefore hidden from non-members.

Privileges may be defined in relation to a group, i.e. an account may have higher level (e.g. moderator) privileges associated with a group; however these privileges only apply within the group.

Groups may be hierarchical, meaning that changes in one group may cause changes in groups arranged above and below that group in a hierarchy. An example of this in operation is given below.

A brief use case example of the operation of the above system will now be given with reference to a web based discussion forum. This example will be used, where required, to give context to the further description below, however it is not a limiting use case. The website through which the discussion forum is provided may be considered to be the interactive application as described above.

Users may access the website of the discussion forum and create accounts. In so doing, the users may select authentication details such as a username and password which are entered to access the discussion forums. Once an account is created, any given user, on any given machine may access the discussion forum by entering the username and password associated with that account. A new account may be given a low level set of privileges, which will be referred to as “forum member” privileges.

Within the discussion forum, there are a number of groups, each discussing a different topic. In this example, an account with only forum member privileges may view the topics of discussion for a given group, but cannot view any posts and cannot contribute to the discussion in the group. However, any forum member level account may request to join a given group. This request needs to be approved by a moderator of the group (i.e. an account with moderator level privileges for that group, discussed below). If approved, the account is provided with a different set of privileges in relation to that group. This set of privileges may be termed “new group member” privileges, and enables that account to view all forum posts in that group, as well as contribute to the forums itself (i.e. make posts to the forum, within that group), however all posts by a new group member account may be moderated before being allowed onto the forum. This may be a requirement for, for example, the first five posts by a new group member account.

After the first five posts by an account with new group member privileges, the account may be provided with a higher level of privileges, termed here as “established group member” privileges, which mean that the posts by that account do not have to be pre-approved by a moderator before being viewable on the forum. This does not stop, if required, a moderator later removing the post if the moderator account sees fit. A use of the distinction between new group member and established group member will be described below.

As mentioned above, the group has at least one moderator. This is an account which has a higher level of privileges in comparison to the new and established group member privileges. The moderator level privileges enable the associated account (i.e. the moderator account) to approve any post requiring pre-approval, as well as to delete or edit any forum post within the group. The moderator level privileges also enable the associated account to approve requests to join the group. This can be contrasted with the new and established group member privileges, which enable an associated account to delete or edit only posts attributed to that account, and prevents the account from approving requests to join the group.

The group has a number of settings. One or more of these settings may be the identity of the one or more accounts provided with moderator level privileges. A further exemplary setting may be the number of moderators which are allowed in the group. These settings may be modified, as will be described below.

The settings, and the moderator level privileges, are applicable only in relation to a given group. Changes to these settings will not change the corresponding settings for other groups. Therefore, while one group may have a setting indicating that only one moderator account is allowed for that group, a different group may allow two moderator accounts. Equally, being a moderator in relation to one group has no effect on other groups. Therefore, an account with moderator level privileges in one group may only have group member privileges, or forum member privileges, in relation to any other group; however this may not be the case, and an account may be moderator on any number of groups.

As mentioned above, groups may be arranged in a hierarchical fashion. In this example this is demonstrated by there being a group for moderators. In other words, all of the moderators of the groups may join (or may automatically be made members of) a higher level moderators group. This group may itself have a moderator.

As mentioned in the background section, an administrator or moderator may not do an adequate job. Therefore, methods by which a computer system, such as the server system 8, may modify one or more settings affecting the operation of the computer system (i.e. operation of the interactive application) will be described.

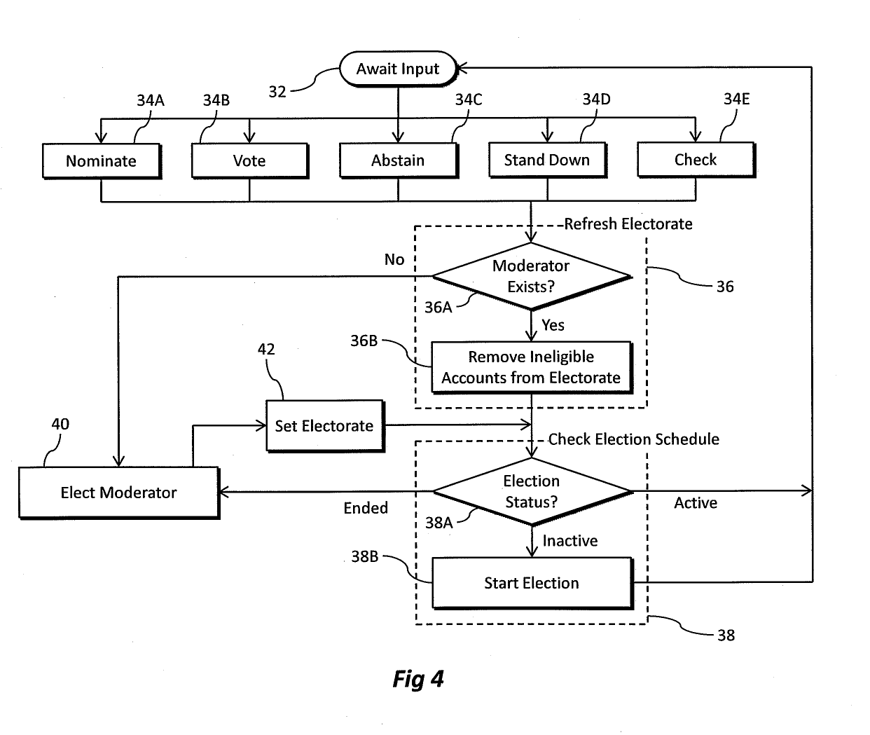

As an example of this, a method by which a moderator may be changed will be described with reference to FIG. 4. This method will be described in terms of an event driven election, which may be performed by the server system 8 in cooperation with inputs received from devices 2 attributed to the accounts. These inputs may include messages indicating that a given account is nominated to be moderator, and/or an input by an account, indicating a preference (or vote) for a particular account to be moderator. For conciseness, it will be assumed that there is only one moderator, and that each account receives a single vote to cast; however this is not a requirement. It will be apparent that, prior to an input identifying an account being received from a device 2, the server system 8 may provide the relevant device 2 (i.e. the account) with data identifying, for example, the options which may be provided as an input—in other words the list of accounts which may be voted for as a moderator. These message flows may include, for example, a browser requesting a webpage from the server system 8, where the webpage shows all nominated accounts, and provides links or buttons enabling a user to select a descried account for a vote. For conciseness, these message flows will not be described in detail and it will be assumed that these message flows have been performed as required.

The method is event driven, in so far as the server system 8 will await, in step 32, an event. Five possible events are indicated by steps 34A to 34E. Following an event, the server system 8 will perform one or more further steps, as described below, before returning to step 32 to await a further event.

In this method, votes may be received at any time; there is no requirement for e.g. a vote or nomination to be cast within a certain limited time frame. Therefore, election here simply indicates a period at the end of which a count will be made. These elections are performed as a loop; that is, upon an event, if it is found that the election has ended, a subsequent election will be started. Votes, nominations and the like will carry over from one election to the next, meaning that an account does not have to re-enter their votes and/or nominations. At the beginning of an election, the server system 8 may record a timestamp; later, upon an event, the server system 8 may compare this timestamp to the current time to determine whether the election has ended.

The following method may be applied to scenarios where the election is of a finite duration, as well as scenarios where the election is of zero duration. Here a zero duration election effectively means that any input will cause a count of the votes, and possible change in the moderator.

During an election, each account may be assigned one of a number of states or roles by the server system 8. These include: abstainer; voter; candidate; and moderator. Any account who has not made a vote, or who has withdrawn or had withdrawn a vote is an abstainer. A voter is any candidate who has provided an input indicating a vote for an account to be moderator. A candidate is any account which has been nominated for the post of moderator. The moderator is the account which has been assigned the state of moderator, i.e. has been provided moderator privileges. An account may have more than one state, for example the moderator will always be a candidate, and both candidates and the moderator are voters (with a vote cast for themselves). The server system 8 may record the inputs received from an account, in particular the last vote cast by a given account. The states of the accounts, and the votes cast, will be maintained from election to election, until changed by either the action of the relevant account, or by a count of the votes.

Accounts may be eligible or ineligible to vote in the election. With reference to the above example of a discussion forum, eligible members may be those who are established group members or higher (i.e. including the moderator). This not only excludes forum members from voting, but also new group members. This may be done to make it harder for dummy accounts to be created and used to corrupt (i.e. rig) a vote. As such, the electorate, i.e. those accounts able to vote, may be a subset of all possible accounts (all the group members). Being an established group member or higher is not the only criteria for eligibility, and other criteria may be used, such as:
the number of posts made in the previous 12 months;
whether the account is still a moderator (if the election is taking place for the moderator only group described above);
a duration of time for which the account has existed, or been a member of a group, or had particular privileges, such as being a moderator or administrator; or
a form of ranking, such as indicated by a reputation index.

As mentioned above, the server system 8 awaits an event in step 32, the events being represented by steps 34A to 34E. The detail of these steps will now be described in detail.

In step 34A, an account may be nominated for the position of moderator. Typically, this will be an account standing, i.e. nominating itself; however this is not a requirement.

Step 34A may be caused by the server system 8 receiving an input from an initiating account indicating that the input is a nomination, the identity of the initiating account, and the identity of the nominated account (if different from the initiating account). Henceforth, initiating account will be used to describe the account to which a given input is attributed. In response to this input, the nominated account is assigned the state of candidate, indicating that that account is a nominated account. The nominated account may be assigned the state of voter with a vote being recorded by the nominated account for itself. The initiating account may also be assigned the state of voter, with a vote being recorded for the new candidate (i.e. the nominated account). In other words, both the initiating account and the nominated account automatically vote for the nominated candidate account. It will be apparent that the initiating account and the nominated account may be the same, in which case only a single vote is cast. If required, any previous votes cast may be withdrawn, as only a single vote per account is allowed. Step 34A, like all of steps 34A to 34E then triggers step 36, titled refresh electorate.

An alternative event, shown by step 34B involves a vote being made. This is where an initiating account provides an input indicating that a vote is being made and identifying one of the candidate accounts. This step causes the server system 8 to withdraw any existing vote cast by the initiating account (if required) and record a vote against the identified candidate for the initiating account. The initiating account is assigned the state of voter by the server system 8, if this was not already the case. Step 34B is followed by step 36.

Step 34C shows a further event—abstain. This is where an account withdraws a vote. As such, the server system 8 will receive an input indicating that the initiating account (the account providing the input) withdraws any vote previously cast. In response, the server system 8 withdraws any existing vote cast by the initiating account. The server system 8 also removes the voter state from the initiating account, giving the account the state of abstainer. Abstain is followed by step 36.

Step 34D, named “stand down”, is where an initiating account indicates that they no longer wish to be a candidate or moderator. Upon receipt of an input indicating this, the server system 8 removes any voter, candidate and (if applicable) moderator roles from the initiating account. The server system withdraws any vote cast by the initiating account, and assigns the abstainer state to the initiating account. The server system may also remove the votes from any account which has voted for that candidate, and likewise assign the abstainer state to these accounts. Step 34D is followed by step 36.

A further possible event is illustrated by step 34E. This event is titled “check”, and effectively forces the server system 8 to check the progress of the election (i.e. perform steps 36 onwards). Check may be initiated by an account, providing a suitable input, or may be performed on a regular basis by the server system 8 itself. The check event 36E may be initiated automatically at the end of an election to ensure that a count is made. As such, check may be provided by a scheduled interrupt within the server system 8.

All of steps 34A to 34E are followed by step 36. This step, titled “refresh electorate”, has two parts. Firstly, in step 36A, the server system determines whether there are any accounts with the moderator state. If not, then the server system 8 will implement step 40 titled “elect moderator”—this step will be described in more detail later. If in step 36A the server system 8 determines that there is a moderator then the server system may in step 36B remove ineligible accounts from the electorate, before proceeding to step 38.

The remove ineligible accounts from electorate step is optional. As described above, accounts may be ineligible to vote, and these accounts may therefore be removed from the electorate. To avoid sudden changes in the number of votes cast, this method may be limited to removing only ineligible accounts which are abstainers, i.e. those which have not cast a vote. This step is used to ensure that changes in the accounts are reflected in the makeup of the electorate.

Following step 36, in step 38, the server system 8 checks the election schedule. This step, like the above, is in two parts. In a first of the steps, step 38A, the server system 8 determines the status of the election. The election may have one of three statuses. The first status—active—means that the election is ongoing. If this is the case, the server system 8 awaits a further event, as represented by the return to step 32.

A second status is where the election has ended. This means that the event which initiated the steps described above was the first since the election had expired. This, as described above, may mean that the event is the first, occurring at a time indicated by a stored timestamp, after the election had ended. If this is the case, then step 40 is implemented by the server system 8.

Finally if the election is inactive—meaning that the election has not only ended, but step 40 has also been performed after the ending of the election—then in step 38B, the server system 8 will restart the election, i.e. by setting a timestamp, and await input in step 32.

Step 40 may be implemented after one of two events, either the refresh electorate step (step 36) is implemented without a moderator existing, or step 38 (check election schedule) is implemented after the end of the election. In step 40, the server system 8 counts the number of votes for each of the candidates—i.e. the number of relevant inputs received by the server system 8. The server system 8 then assigns the moderator state to the account associated with the candidate with the most votes. The moderator state is removed if required from the account associated with the previous moderator. If there is only one candidate, then this candidate will be made moderator. If there are no candidates, then no moderator role is assigned.

In applying and removing the moderator state to/from the accounts, the server system 8 may further change (i.e. assign or remove) the privileges associated with that account. Thus any account for which the moderator state has been removed, may have moderator privileges removed. Equally, any account which is newly given the moderator state may have such moderator privileges assigned.

Step 40 is followed by step 42, in which the server system 8 sets the electorate. This involves the server system 8 identifying eligible accounts and adding them to the electorate. This may be done to ensure that new accounts, or newly eligible accounts, are able to vote in a subsequent election. This step may also include removing ineligible accounts from the electorate, either removing all abstainers, or removing ineligible accounts irrespective of status.

Following step 42, the server system 8 returns to step 38 where, as the election is inactive, the start election step 38B will be implemented.

Brief descriptions of how the above system works in various scenarios will now be provided. In a first scenario, a group has no moderator. This may arise at the beginning of the life of the group, or if a moderator stands down in the absence of any other candidates. In this situation, the nominate event will cause a single account to be made a candidate. In step 36A the server system 8 determines that there is no existing moderator, and therefore proceeds directly to step 40, where the only candidate is elected as moderator, i.e. given the moderator state. An election will then be started in step 38B. During this election, and any subsequent elections, other accounts may stand, and compete against the new moderator; however the new moderator will retain the moderator state until, at least, the end of the election.

In a second scenario, there are two or more candidates (one of which is the moderator). The moderator stands down in step 34D. Again in step 36A, the server system 8 determines that there is no moderator. However, in step 40, as there is still at least one candidate remaining, the moderator state will pass directly to the most popular remaining candidate.

In a third scenario, an account stands against an existing moderator. As a moderator exists (as determined in step 36A) then the server system 8 removes the ineligible accounts (if required) in step 36B and checks the election schedule. This may then start an election, if one is not already active.

In a fourth scenario, the only candidate (automatically a moderator—see above) stands down. This removes both the moderator and candidate states from the relevant account. In this case the elect moderator step (step 40) will find that there are no candidates, and therefore no account will be made moderator. The moderator privileges may be removed from the previous moderator.

In this scenario, instead of proceeding to step 42, in which the electorate is set, and then starting an election, the server system 8 may instead return directly to step 32, and await input. This input will likely be the nomination of a candidate in step 34A, at which point the first scenario above will be followed. When there are no moderators, the server system may provide all accounts with a higher level of privileges, similar to a moderator level. These privileges may be slightly altered from the normal moderator privileges to avoid, for example, two accounts attempting to remove each other from a group. Alternatively or additionally, the aspects of the server system running the election for that group may enter a dormant state. In this state many particulars, such as the identity of the electorate, may be deleted. This saves memory and processing resources.

The particulars (i.e. the identity of the electorate) may be recreated when a new account stands, as the server system 8 will immediately implement the refresh electorate elect moderator and set electorate steps, see the first scenario above).

It will be apparent that in a stable system, i.e. one in which the accounts are not changing votes or casting new votes, and no new candidates stand, the election may remain ended or inactive for what would otherwise constitute many election cycles as there will be no events to cause the method to run. This has the advantage of reducing processing resources, as unnecessary actions, such as making a count of votes in step 40, are not required until an event occurs, changing the situation.

As mentioned before, the election may be of a finite duration. The election duration represent the term of office of an incumbent moderator. Depending on how the system is arranged, the length of an election may be measured in minutes, or in months. In a system where consistency is important i.e. where it is useful for a moderator to remain chosen for a long time, the election cycle may be months in duration, such as 2 or 6 months. Alternatively, where responsiveness to users is key, the election cycle may be 5 minutes or less in duration.

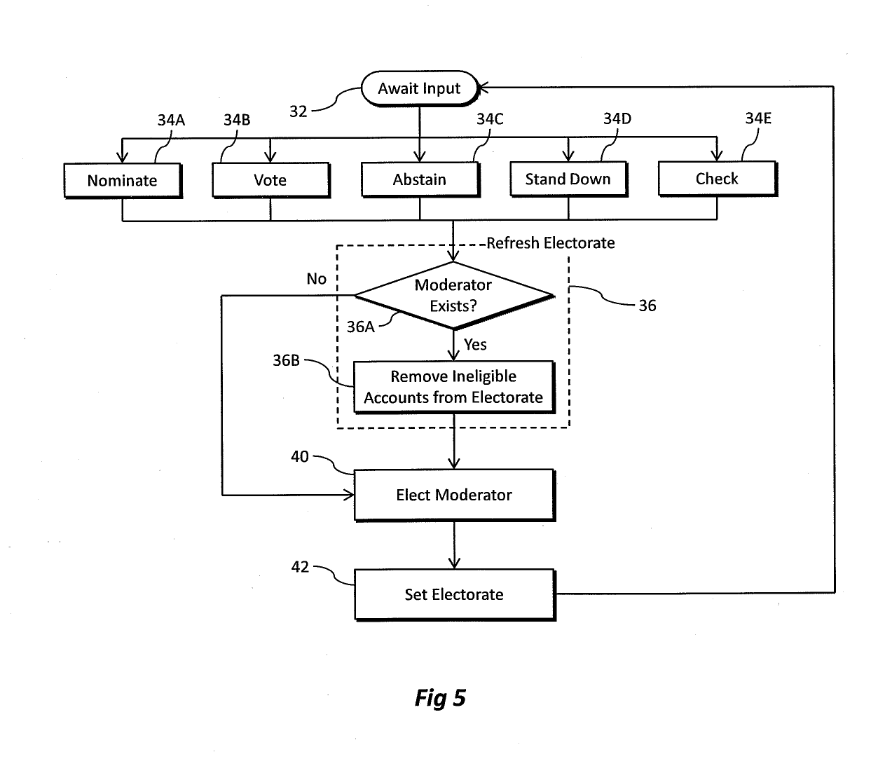

In some embodiments the election may be zero length. FIG. 5 shows a modified version of FIG. 4, which reflects this specific instance. FIG. 5 differs from FIG. 4 in that step 38 has been omitted. In the method shown in FIG. 5, an event will cause an immediate recount of the votes cast. In such cases as the election may be considered neither to be active, or inactive. As such, the refresh electorate may step 36 is followed by step 40, elect moderator, and then set electorate step 42. Following step 42, the server system 8 may, in step 32, await further input. Therefore the method described in FIG. 5 shows a real time system in which any event cause a recount of the votes, and has the potential to cause a change in the moderator.

It will be apparent that this method does not keep cycling, despite using a zero length election, as once the server system 8 has re-counted the votes (after an event), the server system 8 will simply pause, awaiting the next event in step 32.

In the above method, the step to remove ineligible accounts (step 36B) may be limited to only ineligible abstainers. In other words, if an ineligible account has made a vote, then that vote will remain, until the account chooses to abstain from the election. As such, in some embodiments an additional event may be incorporated into the system, that of remove voter. This may take a number of forms. For example, the existing moderator may be able to remove ineligible accounts, even if these accounts are voters. If this is the case then the moderator may be blocked from seeing how the accounts have voted, as the moderator then will be potentially removing votes both for the moderator, as well as votes against. If a remove voter event is included, then this will cause the server system 8 to remove the vote, and make that ineligible account an abstainer. This event, like the other events, will be followed by the refresh electorate method 36, in which the ineligible account may be removed from the electorate.

In the alternative, ineligible voters may be automatically removed during one or both of the set electorate or remove ineligible voters steps.

In some embodiments, the server system 8 may be arranged to alert voters when their chosen candidate stands down (step 34D). In such situations, the vote will no longer be applied—that is the voter may have a valid vote, however it is not cast. In such situations, the voter may be automatically made an abstainer. In such cases, the account may be alerted, and asked to provide an alternative vote (if the account so desires).

The above description describes one method of operating a computerized system, such as server system 8, to enable moderators to be changed by the actions of multiple accounts. In summary inputs, in particular the vote inputs, are received from multiple accounts, and the inputs are collated to determine which account is to be made moderator. This can be contrasted with known systems in which only an existing moderator or administrator can determine who is moderator. As such, in the above system, where a moderator is not doing an adequate job, then the accounts may, through collective, i.e. democratic, action change the moderator.

It will be appreciated that the server system 8 has the ability to assign, and remove, the moderator privileges to/from an account, such privileges being denied from the moderators.

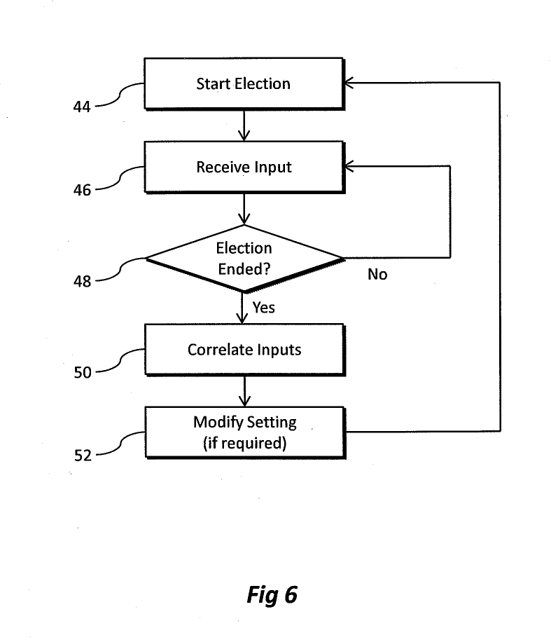

The above description describes how a moderator may be changed, however it will be understood that any setting may be changed in an analogous manner. Indeed, the identity of a moderator or administrator may be considered one of many settings which may be changed by the server system 8, based on the input from a plurality of different accounts. FIG. 6 shows a more generalized method of modifying a setting. This generalized method will again be described in terms of an election having a given duration and, as with the above method, this duration may be zero length. This method may be used to elect a moderator or administrator—that is the setting represents an identity of the moderator or administrator—the changing of such a setting may, as described above, cause privileges to be assigned to, and possibly remove from, accounts. Nevertheless, this method it may be equally used to change any setting. The setting may be a group setting, and be voted on by only the members of the group, or may be a system wide setting, voted on by all accounts.

In step 44, the election is started. As part of this step, the server system 8 may define the options on which the accounts may vote. Where the accounts are voting for a moderator or administrator, then the options may be accounts which are nominated for the role. However, the election may be held to determine any other setting, such as the number of moderators. In this latter case, the server system 8 may establish a range of suitable values for the setting. For example, where the setting defines the number of moderators, the server system 8 may determine the options to be, in effect: increase by one; decrease by one; keep the same; and abstain.

The server system 8 may additionally set the electorate, i.e. identify eligible and ineligible voters as described above; the system 8 may also set a timer, or record a timestamp, if the election is to be of non-zero duration. However, neither of these are essential. If required, the server may take the further step of assigning votes for the available options to various accounts based on past voting behavior. In the first iteration, there will be no past voting behavior, therefore the abstain option may be assigned to each account, how the votes may be assigned differently will be described below.

Following step 44, in step 46, the server system 8 receives an input associated with an account. This input may identify one of the options. Therefore the server system 8 may record this option against the associated account.

Subsequently, in step 48, the server system 8 determines whether the election has ended. In this example, this may involve determining whether the number of non-abstaining votes exceeds a predetermined minimum, and also whether the number of votes for an increase or a decrease is greater than the votes for the other two non-abstaining options. In other words, the server system 8 may cause the election to be maintained until there is a majority voting for a change, at which point the election is ended. Alternatively, the server system 8 may simply determine if the timer has expired, or the timestamp exceeded.

If the election has not ended, then the server system 8 awaits a further input in step 46, thereby receiving multiple inputs, each identifying an option which is being voted for. However if the election has ended then the server system 8, in step 50, correlates the inputs (i.e. the votes) received. This correlating of the inputs may include determining which of the non-abstaining options is most popular, i.e. is associated with the greatest number of inputs. In correlating the inputs the server system 8 may determine if there is a quorum of voters or a majority, such as a simple majority, an absolute majority (i.e. taking into account the abstaining votes), a two-thirds majority or any similar threshold.

Having correlated the inputs in step 52, the server system 8 may modify the setting, if this is indicated by the correlating step (i.e. if there is a sufficiently large number of votes for a change).

Having modified the setting, or determined that the setting does not need to be modified, the server system 8 may re-start the election. As mentioned above, this may involve determining the options available for voting on, and also assigning votes based on past voting behavior. If no change was made in the election, i.e. the majority vote was for the status quo, then previously selected options will simply be maintained for each account. However, an example of how the latter might be done in the case of a change will now be provided using the example of the number of moderators. It will be assumed that the correlated inputs (i.e. the vote) indicated that the number was to increase by one.

As such, the server system 8 may assign a vote of “keep the same” to all the accounts which voted for an increase, and a vote of “decrease by” one to all the accounts which voted for either a decrease or for the old setting (now increased) to be maintained. This ensures that once the election is over, the option attributed to each of the accounts reflects the previous vote.

The above method may be used to elect a moderator or administrator, i.e. change the level of privileges for an account on the server system 8. Alternatively, or in addition, the above method may be used to change settings affecting how the system operates.

Some examples of the use of the above system in exemplary interactive applications will now be described.

In a first example, the system may be used for online social networks. Many of these online social networks have groups. A given group may be moderated by one or of its members. Typically, the founding member is automatically appointed as moderator. If a new moderator is required then the incumbent moderator can manually appoint another member. If the appointment is contentious, members may indicate their dislike of the appointment. However, they rely upon the incumbent moderator to honor their preference. The above describe system removes this reliance on the incumbent moderator and appoints the preferred candidate automatically. If members do not accept an incumbent moderator, they can challenge and forcibly change the moderator. This provides a way to resolve contention for the appointment without deferring to a human arbiter. In addition, the group may have any number of further settings (i.e. in addition to the identity of the moderator). These settings might include the number of moderators allowed for the group; whether the group is open, closed, hidden or the like; whether there are any entry requirements for the group, i.e. does a moderator, or existing member have to approve an application, or can anyone join. It will be appreciated that this list is not limiting, and that any appropriate setting may be altered by the systems described above.

The above system may also be applied to discussions forums. Typically, forum moderators are appointed by administrators or super-moderators. The above described system enables users of a given forum (i.e. group in the above language) to appoint a moderator of their choosing. This means that users can remove a moderator if they do not feel that the moderator is doing a good job. They do not depend upon persuading an administrator or super-moderator to remove the existing moderator. Similarly, settings may be changed. In the example above, a new group member had to make five posts before becoming an established group member. As such the number of posts required may be altered by the voting system.

The above system may also be used to appoint administrators with e.g. system-wide privileges. In such cases, all accounts, not just the members of a given group may be allowed input.

Embodiments may be applied to document and file management systems. In these systems the documents and files need to be kept in order. Typically, this relies on unelected administrators. The above system lets system users elect administrators. This means that administrators are more likely to be trusted by the users that they serve and absent file or folder owners can be deposed without getting hold of a super administrator, typically via an IT helpdesk.

One scenario to which the above system may be applied is to do with online collaboration tools. With these tools users typically form groups and even form hierarchies of groups. From this a reporting chain may be formed (which is often depicted graphically as an organization chart). Typically, managers are appointed ‘top-down’. The above system enables managers to be appointed ‘bottom-up’. This should help reduce any stranglehold middle-management may have on new talent; it should mean that the availability of managers should scale in proportion to demand; it should result in better quality management because it eliminates the possibility of patronage; it should make very large organizations practical because power conflicts are resolved efficiently.

In the description above, a distinction is made between the members of a group and the members of the electorate for that group. The utility of making such a distinction may be illustrated with reference to an interactive application in which hierarchical groups are arranged in three tiers. The top tier is the root group, the second tier has two groups and the bottom has four groups. Furthermore, the settings of the interactive application stipulate that all the accounts can vote for the administrator of the root group.

During an election for the administrator of the root group, one of the groups in the second tier breaks free and forms its own organization. This causes a sudden change in the number of accounts in the original organization. This sudden change in the number of accounts might likewise cause a large disruption in the election, as a large number of votes would cease to be applicable. Equally, the candidate for the administrator position might have been a member of the now absent group.

One method of solving this problem is to reset the election, and the electorate, if there is a change in the electorate over a predetermined amount, for example 10%. However an alternative is to distinguish the members of the group from the electorate. This has the advantage that upon an organizational break up like the above, candidates and voter may no longer be eligible, but they remain, thus reducing the disruption. These candidates and voters may then gradually be removed from the electorate as they abstain, or as they are removed using the remove event described above.

The above examples describe the interactive application being provided by the server system 8; that is the server system 8 comprises the interactive application system. However, it will be appreciated that embodiments have applicability to larger systems where the server system 8 provides the functionality to receive and correlate the inputs, and where the server system 8 is connected to an interactive application system providing the interactive application. Furthermore, a single server system 8 may provide the election functionality to multiple interactive application systems each providing a different interactive application. As such, the server system 8 may not itself change the privileges assigned to the elected moderator, or indeed change any setting, but may signal the relevant system with the result of an election and cause the appropriate changes to be made.

In the above examples, only group members may be nominated for a post of e.g. moderator. However this need not be the case, and the server system 8 may be arranged such that outside talent, i.e. an account from outside the group, may be nominated for a post.

In embodiments, votes may be automatically cast for a nominated account—typically by the nominator, and the nominated account. However, this is not a requirement, and nomination may not cause automatic voting.

In some embodiments, more than one account may be required to approve a nomination before an account is nominated, and is therefore offered as an option for election which is presented to the larger electorate. As such, the server system 8 may require nominations of a given account from a number of accounts, before that account is available to be voted for. The number required may be a setting, which itself may be changed in a democratic manner as described above.

Accounts may be allowed more than one vote. This may be used, in particular, in situations where more than one moderator may be elected. For example, in a situation where three moderators are to be elected, each voter may be provided with three votes. This may reduce the occurrences of tactical voting.

In addition, a so called alternative vote system may be used, in which each account provides a list of the available options in order of preference. The server system 8 may then collate the inputs for all of the candidates, and then remove the one candidate with the lowest number of votes from the nominations, re-assigning votes based on the order of preference as required.

It will be appreciated that groups are not essential. The interactive application may simply not use groups at all, and simply have a system wide vote for a moderator, administrator, or any other setting. Alternatively, groups may be used in the interactive application, but some elections may be held on a system wide basis, and thereby include all eligible accounts.

Equally the distinction between the electorate and larger body of accounts, and of eligibility is not a requirement, and in some systems, all accounts may be allowed a vote.

While the election of a moderator or administrator has been described above, any form of representative may be elected. For example, one group could use an election to elect an account to represent that group in another group. The elected account may not be provided with any moderator type privileges, rather the privileges, if any, simply relate to the ability of that account to represent the group. Alternatively, in a discussion group, an “new group member” may have to receive a number of votes before that account is elevated to an “established group member”. It will be apparent that other examples are envisaged.

While the above describes detailed embodiments, for completeness, some embodiments will be described in summary form.

In one embodiment there is provided a computing system for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the computing system being configured to: receive a plurality of inputs in relation to a first setting of the one or more settings, the inputs being associated with different ones of the plurality of the accounts; correlate the plurality of inputs; and modify the first setting in dependence on the correlated inputs.

In known interactive application systems, such as discussion forums or social networks, settings controlling the operation of the interactive application system are changed through input from a moderator or administrator account. While there may be multiple administrator accounts, only a single such account is required to change a setting in these known systems. However the user or users associated with the administrator or moderator account may not do an adequate job.

The above computing system provides an improved method of changing such settings by correlating a plurality of inputs associated with different ones of the plurality of accounts and modifying a setting based on the correlated inputs. This enables the actions of multiple accounts to cause a change, irrespective of whether an administrator account approves. In other words, the correlated plurality of inputs may change a setting, in comparison to known systems in which only a single administrator account changes a setting.

The inputs may each identify a selected one of a plurality of options associated with the first setting. The computing system may be configured to determine the number of said inputs which identify each of the options whereby to correlate the plurality of inputs. The computing system may operate such that the number of inputs effects the change in the first setting. As such, in embodiments, the inputs may be considered votes for a particular option, and the number of votes determines whether the system modifies the first setting, and what the setting is modified to. This enables, for example, the most popular option to be used for the first setting. This in effect brings a democratic or referendum type operation to the choice of settings for the computing system, in comparison to known systems in which such settings are autocratically set by an administrator. Each account may be allowed a limited number of inputs, such as only a single input. It will be appreciated that, in embodiments, despite this limitation on number, an account may change its input, i.e. rescind an earlier input and provide an alternative input. This would still only count as a single input.

The computing system may be configured to modify the first setting to a one of the plurality of options associated with a largest number of the inputs. Alternatively or additionally, the computing system may be configured to determine whether a number of the inputs associated with one or more of the options is greater than a threshold, and to modify the first setting if the number of inputs is greater than the threshold. In other words, in some embodiments, the option having the largest number of inputs (i.e. votes) may the option to which the first setting is changed. Equally, the setting may only be changed if the number is greater than a threshold, i.e. if there is a majority, or if the number of votes makes a quorum. It will be appreciated that a majority, if required, may be indicative of a simple majority, absolute majority, two-thirds majority or any appropriate threshold.

The accounts may each be configured with privileges whereby to control the authorization by the interactive application of the interactions, and the computing system may be configured to change the privileges assigned to one or more of the accounts whereby to modify the first setting. In such cases, the first setting may be associated with the identity of an account to which a set of said privileges are to be assigned by the computing system, and the inputs each identify one account from a one or more nominated accounts.

In other words, the computing system may change the privileges assigned to the accounts and thereby change the nature of the authorization by the interactive application. These privileges may enable, or disable the associated account in performing certain interactions within the interactive application. In embodiments, this change in the privileges assigned to an account may be done based on the inputs. In other words, the first setting may be associated with the identity of an account to which certain privileges are to be assigned, and the inputs may identify which account being voted for the privileges. This enables privileges to be given to accounts based on the actions of multiple accounts, rather than the action of a single administrative account.

The computing system may further be configured to: receive at least one further input identifying an account, and based on the at least one further input, include the account in the plurality of nominated accounts. Alternatively or additionally, the computing system may be configured to: receive at least one further input identifying an account, and based on the at least one further input, remove the account from the plurality of nominated accounts.

A further input may therefore be used to nominate an account for particular privileges. An account may nominate itself, or another account using this further input. Once nominated, the account may be made available in, e.g. a nomination list, so as to be identified in the original inputs, i.e. the ones which are correlated. It will be apparent, that in some embodiments, all accounts may be automatically nominated. It will further be apparent that in some envisaged embodiments, an input may not identify an account and by contrast may indicate, in effect, that the account stands down from being nominated.

In some embodiments, a first set of privileges comprises a relatively high level of privileges, and a second set of privileges comprises a relatively low level of privileges, and the computing system may be configured to assign the first set of privileges to a one of the accounts whereby to modify the first setting. The computing system may further be configured to assign the second set of privileges to at least one other of the accounts whereby to modify the first setting.

In other words, the inputs may cause the computing system to assign a relatively high level of privileges (i.e. administrator or moderator level privileges) to one of the accounts. In other words, through multiple inputs (i.e. votes) from multiple accounts, an administrator may be elected. When a first account is provided with high level privileges, e.g. when an administrator is elected, at least one of the accounts may have high level privileges removed, i.e. a previous administrator may be removed.

Both the first and second set of privileges may prevent an associated account from assigning the first set of privileges to a further account. To avoid any single account from providing privileges to itself, or to another account, the computing system may be set up such that neither of the first or second set of privileges enable any account from making such changes. In other words, an existing administrator or moderator (having the first, relatively high level, set of privileges) is unable to make any other accounts administrator or moderator. Only through the inputs from multiple accounts can such a change be made.

The computing system may be configured to: set a timer upon receipt of an input; and upon expiry of the timer, correlate the plurality of inputs. To avoid sudden changes, the computing system may set a timer, and upon expiry of the timer may then correlate the inputs. This in effect creates an election, of a duration defined by the timer, and during the election, inputs will be received, but no action will be taken to make changes until after the election has ended. The timer may be started by an input related to a first setting, however, the timer may also be started upon changes in e.g. the list of nominated accounts.

The computing system may be configured to receive further said inputs following the modification of the first setting and, upon receipt of said further said inputs, correlate the further said input with the said inputs. The computing system may react to subsequent inputs by correlating the new inputs with the original inputs. This enables the system to react to new inputs without having to re-run an election, i.e. receiving repeat inputs from each accounts.

In some embodiments, the computing system may be configured to receive multiple inputs from a given account, and to use only a single said input whereby to correlate the plurality of inputs. As such, multiple inputs may be received from a given account. In these cases, the computing system may disregard earlier inputs and use only the latest input. This enables an account to change its input.

The accounts may be arranged in a plurality of groups, the first settings may control the operation of the interactive application system with regards to a first group, and the plurality of inputs may be received from accounts which are members of the first group. In other words, the accounts may be arranged in groups, with associated settings. As such, the correlating may take into account only inputs relevant to a given group. Further inputs may be received, relating to other groups. These may be separately correlated by the computing system.

In some embodiments the computing system may be configured to: receive a second plurality of inputs in relation to a second setting of the one or more settings; correlate the plurality of inputs related to the second setting separately to the plurality of inputs related with the first setting; and modify the second setting in dependence on the correlated second inputs.

The computing system may be configured to: identify a subset of the plurality of accounts based on one or more eligibility criteria; and disregard, and/or prevent the reception of, inputs associated with an account which is outside the subset of the accounts. Furthermore, the computing system may be configured to: during the receiving of the plurality of inputs, identify a second subset of the plurality of accounts based on the one or more eligibility criteria; and disregard, and/or prevent the reception of, any subsequent inputs in relation to the first setting where the inputs are associated with an account which is outside the subset of the accounts.

In other words, an electorate may be defined. This electorate may be a subset of the available accounts. As such, the computing system may choose to only accept, or correlate inputs (i.e. votes) from the electorate and may disregard or prevent the reception of inputs from the other accounts. The computing system may further update the electorate during an election, removing ineligible accounts and thereby preventing input being received in relation to those ineligible accounts. This may also cause any previous inputs (i.e. previously cast votes) from being used in the correlation.

In a further embodiment there is provided a computer program product comprising a non-transitory computer-readable storage medium having computer readable instructions stored thereon, the computer readable instructions being executable by a computerized system to cause the computerized system to perform a method for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the method comprising: receiving a plurality of inputs in relation to a first setting of the one or more settings, the inputs being associated with different ones of the plurality of the accounts; correlating the plurality of inputs; and modifying the first setting in dependence on the correlated inputs.

There may be provided a non-transitory computer-readable storage medium comprising a set of computer-readable instructions stored thereon, which, when executed by a processing system, cause the processing system to carry out any of the methods as described above.

The processing systems described above may comprise at least one processor and at least one memory including computer program instructions, the at least one memory and the computer program instructions being configured to, with the at least one processor, cause the apparatus at least to perform as described above.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A computing system for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the computing system being configured to:
receive a plurality of inputs in relation to a first setting of the one or more settings, the inputs being associated with different ones of the plurality of the accounts;
correlate the plurality of inputs; and
modify the first setting in dependence on the correlated inputs.

2. The computing system of claim 1, wherein the inputs each identify a selected one of a plurality of options associated with the first setting.

3. The computing system of claim 2, wherein the computing system is configured to determine the number of said inputs which identify each of the options whereby to correlate the plurality of inputs.

4. The computing system of claim 3, wherein the computing system is configured to modify the first setting to a one of the plurality of options associated with a largest number of the inputs.

5. The computing system of claim 3, wherein the computing system is configured to determine whether a number of the inputs associated with one or more of the options is greater than a threshold, and to modify the first setting if the number of inputs is greater than the threshold.

6. The computing system of claim 1, wherein the accounts are each configured with privileges whereby to control the authorization by the interactive application of the interactions, and wherein the computing system is configured to change the privileges assigned to one or more of the accounts whereby to modify the first setting.

7. The computing system of claim 6, wherein the first setting is associated with the identity of an account to which a set of said privileges are to be assigned by the computing system, and the inputs each identify one account from a one or more nominated accounts.

8. The computing system of claim 7, wherein the computing system is configured to:
receive at least one further input identifying an account, and
based on the at least one further input, include the account in the plurality of nominated accounts.

9. The computing system of claim 7, wherein the computing system is configured to:
receive at least one further input identifying an account, and
based on the at least one further input, remove the account from the plurality of nominated accounts.

10. The computing system of claim 7, wherein a first set of privileges comprises a relatively high level of privileges, and a second set of privileges comprises a relatively low level of privileges, and the computing system is configured to assign the first set of privileges to a one of the accounts whereby to modify the first setting.

11. The computing system of claim 10, wherein the computing system is configured to assign the second set of privileges to at least one other of the accounts whereby to modify the first setting.

12. The computing system of claim 10, wherein both the first and second set of privileges prevent an associated account from assigning the first set of privileges to a further account.

13. The computing system of claim 1, wherein the computing system is configured to:
set a timer upon receipt of an input; and
upon expiry of the timer, correlate the plurality of inputs.

14. The computing system of claim 1, wherein the computing system is configured to receive further said inputs following the modification of the first setting and, upon receipt of said further said inputs, correlate the further said input with the said inputs.

15. The computing system of claim 1, wherein the computing system is configured to receive multiple inputs from a given account, and to use only a single said input whereby to correlate the plurality of inputs.

16. The computing system of claim 1, wherein the accounts are arranged in a plurality of groups, and the first settings control the operation of the interactive application system with regards to a first group, and wherein the plurality of inputs are received from accounts which are members of the first group.

17. The computing system of claim 1, wherein the computing system is configured to:
receive a second plurality of inputs in relation to a second setting of the one or more settings;
correlate the plurality of inputs related to the second setting separately to the plurality of inputs related with the first setting; and
modify the second setting in dependence on the correlated second inputs.

18. The computing system of claim 1, wherein the computing system is configured to:
identify a subset of the plurality of accounts based on one or more eligibility criteria; and
disregard, and/or prevent the reception of, inputs associated with an account which is outside the subset of the accounts.

19. The computing system of claim 18, wherein the computing system is configured to:
during the receiving of the plurality of inputs, identify a second subset of the plurality of accounts based on the one or more eligibility criteria; and
disregard, and/or prevent the reception of, any subsequent inputs in relation to the first setting where the inputs are associated with an account which is outside the subset of the accounts.

20. A computer program product comprising a non-transitory computer-readable storage medium having computer readable instructions stored thereon, the computer readable instructions being executable by a computerized system to cause the computerized system to perform a method for modifying one or more settings controlling the operation of an interactive application system, wherein the interactive application system is configured with a plurality of accounts to enable, at least, attribution and authorization by the interactive application system of interactions with the interactive application system, and the one or more settings control the operation of the interactive application system with regards to the interactions and the accounts, the method comprising:
receiving a plurality of inputs in relation to a first setting of the one or more settings, the inputs being associated with different ones of the plurality of the accounts;
correlating the plurality of inputs; and
modifying the first setting in dependence on the correlated inputs.
